(19) United States
(12) Patent Application Publication
(10) Pub. No.: US 2025/0094884 A1
(43) Pub. Date: Mar. 20, 2025

(54) MULTIDAY TIMED ENTRY TICKET SYSTEM FOR RECURRING EVENTS

(71) Applicant: RUNSIGNUP, INC., Moorestown, NJ (US)

(72) Inventors: Stephen Charles SIGWART, Berlin, NJ (US); Benny CHEN, Hamilton Township, NJ (US)

(21) Appl. No.: 18/809,238

(22) Filed: Aug. 19, 2024

Related U.S. Application Data
(60) Provisional application No. 63/533,450, filed on Aug. 18, 2023.

(51) Int. Cl. G06Q 10/02; G06Q 10/1093

(52) U.S. Cl. CPC G06Q 10/02; G06Q 10/1093

(57) ABSTRACT

A computer implemented method for event management and participation, comprises providing a timeslot rules table, the timeslot rules table being an immutable table of a first plurality of timeslots, the timeslot rules table defining a plurality of scheduling rules. The method further comprises providing a timeslot additions table, the timeslot additions table including a second plurality of timeslots being different from the first plurality of timeslots. The method further comprises providing a calendar recurring rule table, the calendar recurring rule table including recurring pattern rules for one or more of the timeslot rules table and the timeslot additions table. The method further comprises providing an exceptions table, the exceptions table including one or more exceptions to the scheduling rules. The method further comprises providing efficient data storage that can span tens of thousands of “tenants” or customers all having complex multi-day timeslot data in the same computer system.

### CROSS-REFERENCE TO RELATED APPLICATION(S)

This application claims the benefit of priority to U.S. Provisional Patent Application Ser. No. 63/533,450 entitled “MULTIDAY TIMED ENTRY TICKET SYSTEM FOR RECURRING EVENTS,” filed Aug. 18, 2023, the disclosure of which is incorporated herein by reference in its entirety.

### FIELD OF THE INVENTION

The present disclosure generally relates to ticketing systems. In particular, the present disclosure is related to multiday timed entry ticket system for recurring events.

### BACKGROUND

A common challenge for ticketing systems for events that recur is that there can be tens of thousands of time slots per event with many parameters such as pricing, caps, questions, store items, discount and membership availability to each timeslot. A system that can handle the complexity of entry ticketing for recurring events is needed.

### SUMMARY

In some embodiments, a computer implemented method for event management and participation, comprises providing a timeslot rules table, the timeslot rules table being an immutable table of a first plurality of timeslots, the timeslot rules table defining a plurality of scheduling rules. The method further comprises providing a timeslot additions table, the timeslot additions table including a second plurality of timeslots being different from the first plurality of timeslots. The method further comprises providing a calendar recurring rule table, the calendar recurring rule table including recurring pattern rules for one or more of the timeslot rules table and the timeslot additions table. The method further comprises providing an exceptions table, the exceptions table including one or more exceptions to the scheduling rules. The method further comprises providing efficient data storage that can span tens of thousands of “tenants” or customers all having complex multi-day timeslot data in the same computer system. The method further comprises receiving a ticketing request from a user for one or more recurring events. The method further comprises determining whether the ticketing request is serviceable based a database including the timeslot rules table, the timeslot additions table, the calendar recurring rule table, and the exceptions table displaying serviceable ticketing options to the user.

In some embodiments, a computer implemented method for presenting complex multi-day recurring timeslot data to event directors in a way that makes it easy to configure events, comprises presenting a visual calendar based view that displays time slot data with controls to view and edit details. The method further comprises presenting alternate visual views such as day tiles or text and timeslot mixed panels, whereby multiple timeslots are easily and simply configurable by presenting them as a group and allowing for the configuration of all timeslots in a given group.

In some embodiments, an apparatus comprises a processor, a database, and a memory operatively coupled to the processor. The memory stores instructions to cause the processor to receive an event request including event data for one or more recurring events from an event planner operating a compute device. The processor is further caused to generate, based on the event request, a timeslot rules table. The timeslot rules table includes an immutable table of a first plurality of timeslots, the timeslot rules table defining a plurality of scheduling rules. The processor is further caused to generate, based on the event request, a timeslot additions table. The timeslot additions table includes a second plurality of timeslots being different from the first plurality of timeslots The processor is further caused to generate, based on the event request, a calendar recurring rule table. The calendar recurring rule table includes recurring pattern rules for one or more of the timeslot rules table and the timeslot additions table. The processor is further caused to generate, based on the event request, an exceptions table including one or more exceptions to the scheduling rules. The processor is further caused to store the timeslot rules table, the timeslots additions table, the calendar recurring rule table, and the exceptions table in the database. The processor is further caused to receive a ticketing request from a user operating a compute device for one or more recurring events associated with the event request from the event planner. The processor is further caused to determine whether the ticketing request is serviceable based on a database including the timeslot rules table, the timeslot additions table, the calendar recurring rule table, and the exceptions table. The processor is further caused to generate a visual calendar based view to the compute device operated by the planner to enable the planner to modify details of the one or more recurring events. The processor is further caused to generate a visual calendar based interface to the compute device operated by the user to enable the user to purchase a ticket for the one or more recurring events.

### BRIEF DESCRIPTION OF THE DRAWINGS

FIG. 1 shows a unique database architecture that allows for efficient storage and processing of recurring events, while also adding capabilities for both event directors and users, according to one or more embodiments

FIG. 2 shows an interface wherein Event Directors can easily add Timeslot Groups, according to one or more embodiments.

FIG. 3 shows a Timeslot Group called “Saturday Daytime Timeslots,” according to one or more embodiments.

FIG. 4 shows a Timeslot Group with the addition of 2 evening events, according to one or more embodiments

FIG. 5 shows the updated large Schedule interface, according to one or more embodiments

FIG. 6 shows the updated day view showing two Timeslot Groups, according to one or more embodiments

FIG. 7 shows advanced pricing rules set up on an overall basis in the dashboard, according to one or more embodiments

FIG. 8 shows the three pricing options available on a per Timeslot Group or individual Timeslot basis from the Schedule page, according to one or more embodiments

FIGS. 9 and 10 show the user interface for the purchase path which allows for presenting the user a purchase decision of date, timeslot and tickets in any order, according to one or more embodiments

FIG. 11 shows what the date picker options will be, according to one or more embodiments.

FIG. 12 shows Timeslots within a date that have more advanced features for displaying data and text and images, according to one or more embodiments.

FIG. 13 shows a calendar-based report for tickets sold, and additional data (e.g. Revenue) according to one or more embodiments.

FIG. 14 shows a menu of additional information for specific days on the calendar-based report, according to one or more embodiments.

FIG. 15 shows an alternate table view based on day of the report of FIG. 13, according to one or more embodiments.

FIGS. 16-23 show example interfaces for setting up a ticket event, according to one or more embodiments. FIG. 22 shows a visual representation of a complex, multi-ticket event setup with overlapping timeslots.

FIG. 24 is an example flow diagram of a method for event management and participation, according to one or more embodiments.

FIG. 25 is an example flow diagram of a method for presenting complex multi-day recurring timeslot data to event directors in a way that makes it easy to configure events, according to one or more embodiments.

FIG. 26 is a representative diagram illustrating data efficiency of how data is stored and displayed to a user, according to some embodiments.

FIG. 27 is a block diagram of a system illustrating multiday timed entry ticket system for recurring events, according to some embodiments.

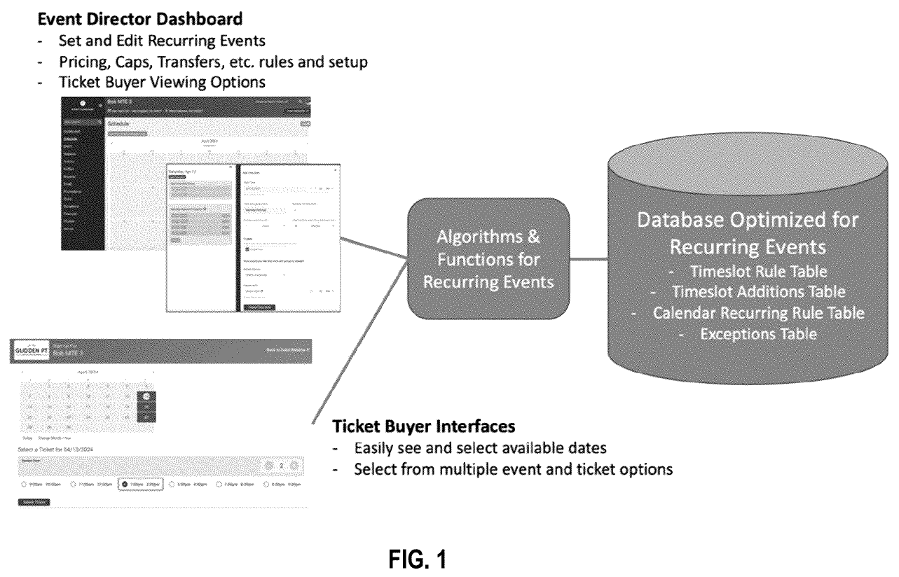

### DETAILED DESCRIPTION OF THE INVENTION

Event ticketing and management systems are comprehensive software solutions designed to streamline the process of organizing and handling various types of events, such as, for example, conferences, seminars, workshops, festivals, tours, and sports events. These systems can offer a wide range of features and tools to simplify event planning, registration, communication, admissions, bookings, and data management, providing organizers with efficient ways to ensure successful and smooth events.

Key features of event ticketing and management systems often include:

Online Registration: These systems allow participants to register for events and/or purchase tickets conveniently through online platforms, eliminating the need for manual paper-based tickets.

Payment Processing: Seamless integration with secure payment gateways to handle registration fees, ticket sales, and other financial transactions related to the event.

Event Website Creation: Many systems offer tools to build event websites or landing pages, providing all the essential event details, schedules, and registration forms in one place.

Communication Tools: Built-in email and text (SMS) communication and notification systems to send event updates, reminders, and important information to participants, speakers, sponsors, and other stakeholders.

Attendee Management: Efficiently manage attendee data, including contact information, preferences, and attendance status, for better event planning and personalized experiences.

Ticketing and Badge Generation: Generate electronic tickets or badges for registered participants, streamlining check-in processes during the event.

Analytics and Reporting: Robust reporting and analytics features to track registration numbers, attendee demographics, financial reporting, marketing effectiveness and other critical data, aiding in future event decision-making.

Mobile App Integration: Integration with mobile apps to enhance attendee engagement, execute efficient event check in, provide event schedules, maps, and networking opportunities.

Surveys and Feedback: Tools for gathering post-event feedback and surveys to assess participant satisfaction and identify areas for improvement.

Social Media Integration: Linking the event management system to social media platforms for marketing, promotion, and community engagement.

Resource and Venue Management: Efficiently allocate or limit on-site resources, manage event logistics, track capacity or attendance, and coordinate with venues, vendors, and sponsors.

These systems simplify the entire event lifecycle, from planning and registration to post-event feedback and analysis. They save time and effort for organizers while enhancing the participant experience, ultimately contributing to the success of any event. Event registration and management systems have become indispensable tools in the modern event planning landscape, enabling organizers to execute events efficiently and effectively.

Some events have multiple ticketing opportunities that are recurring in nature such that the event might occur daily, hourly, or even shorter (e.g., 10 minute timeslots) over an extended period of days, weeks or indefinitely. For example, a Halloween corn maze event might need to sell tickets for timeslots starting every 10 minutes from 4 p.m. to 10 p.m. for every day in October. In addition to this set schedule, the event may need to offer modified pricing for weekend events, different ticket caps for certain days, and other features such as discounts, store items, volume pricing, custom data collection (questions), etc.

In addition to the data complexity and volume that might be required for a recurring event, the system as described herein is a multi-tenant (multi-customer) cloud based system that must handle tens of thousands of customer's events in a single system.

The system as described herein can be used for MultiDay Timed Entry Ticketing for Recurring Events in a multi-tenant system. This is a common challenge of ticketing systems for events that recur since there can be tens of thousands of time slots per event with many parameters such as pricing, caps, questions, store items, discount and membership availability to each timeslot. In a multi-tenant system, that complexity is multiplied by millions of events each with tens of thousands of time slots. It is noted that while the embodiment described herein is directed to multiday timed entry ticketing for recurring events, it can be applied to any recurring event where participants are required to register for the event and provide relevant information to manage and administer the process.

There are three fundamental challenges to creating a system for recurring events in this described embodiment:
Optimizing storage and retrieval of information, e.g., in a multi-tenant SaaS system, with hundreds of thousands of events each with potentially thousands of time slots over a period of decades. In other words a very large and complex database structure that needs to be optimized.
Ease of configuration, setup, change and reporting for Event Directors in creating and managing their event ticketing for recurring events and being able to perform bulk operations across multiple timeslots with minimal effort.
Ease of signup for ticket purchasers, in that the system must be able to process the inventory of all ticket options in the database and present the user with purchase options that meet their criteria, and do it with sub-second response time so as to capture the attention of the purchaser so that it leads to a successful ticket sale.

### SUMMARY OF THE INVENTION

The system as described herein solves the described problems by developing a unique database architecture, data processing logic and user interface that allows for efficient storage and processing of recurring events, while also adding capabilities for both event directors and ticket purchasers.

### Database Architecture

The key to the database architecture is a data structure that is optimized for time slots that re-occur over days, months, years, or indefinitely. Traditionally this would be solved with data records for each time slot with potential duplication of meta-data such as pricing, sales windows, ticket caps, etc. The architectures as described herein utilizes a rule based system that can represent tens of thousands of time slots with much less data. It can also represent multi-day timeslots that may not have an end date (such as a tour group that runs 4 hour tours every day for years) without incurring the data demands of all of the future timeslots. This unlocks efficiency from a data storage and retrieval perspective, faster execution of event director and ticket buyer applications and a system that can continue to perform well after years of multi-day timeslot data is accumulated.

### Timeslot Rule Table

This sets the rules for how a timeslot can recur within a Day—for example there is hourly entry into a Halloween Haunt or a Botanical Garden. If Weekday hours are different from weekend hours, then 2 rules could be set up, one set for weekdays and a second one for weekends.

The key parameters for defining the start times would comprise, at least:
ID and Name
First Slot Start Time (e.g., 10 AM)
Slot Duration and Slot Offset (e.g., 1 Hour and 2 Hours)
Number of recurring Slots per Day (e.g., 6 Slots)

The examples above would automatically set 10, 12, 2, 4 and 6 as the start times for each 1 hour slot.

The other key fields connect various settings to a rule—for example which ticket levels are available, pricing, caps, etc.

This is an immutable table except for the Name. This makes sure that tickets sold associated with the rules tied to this table are kept permanently, and are consistently applied time after time.

It's also immutable because exceptions to the rule depend on the start time of each slot.

Using the example given above, let's say 12 PM was changed to 1 PM if the rule is mutable and the slot offset was changed to be 1 hour instead. The new time slots would be 10, 11, 12, 1, 2, and 3, now the exception creates an error because it was meant for the 2nd occurrence of the rule, but 12 PM in the updated rule is actually the 3rd occurrence.

### Timeslot Additions Table

This creates timeslots that are not a regular pattern defined by the rule—but they can associate with the recurring rule settings. This is useful for making the event management applications easier to build and understand. For example, someone might want to add a 5:00 timeslot, or change the duration of the 12:00 timeslot to be only 30 minutes.

### Calendar Recurring Rule Table

This takes a Timeslot Rule (and Additions) and makes it repeat on a certain pattern (Note this is not necessarily tied only to the timeslot rule, so it can be used for other applications as well in the future). The system as described herein can include the management of additional metadata pertinent to tickets. For tickets, this is useful because a Halloween Haunt might have common hours every Weekday except Monday (closed), and different hours for each Saturday and each Sunday of October. This is also very useful for admissions types of applications where a Botanical Garden would be able to set up tickets once and it would last for years—easy for event directors and much more efficient from a database perspective.

The Calendar Recurring database table is very efficient. It uses a bitwise database field to set:
Recurring Days of Week
Recurring Days in Month
Recurring Weeks in Month
Recurring Months
And an ending Timestamp

### Exceptions Table

This table is used to define things that are different from the defined rules—different duration, different time, different ticket levels (canceled ones), different time slot config for specific ticket levels, different calendar recurring rule.

This includes both regular time slots and additional time slots:
When changes like time slot start time, duration, canceled, or cancel ticket level occur, a row will be added.
Used to figure out if it's an exception for a regular time slot or an additional time slot.
Used to apply the exception only to one level.
Used to apply the change to more than just one day.
If editing a time slot with ticket levels that have sales already:
   Warn the director about it.
   Update for affected sold tickets.
   Allow sending notifications to affected ticket holders.

### Data Efficiency:

When adding a new exception, previous related exceptions are checked, and see they can be deleted. An example would be if the start time twice was changed twice, the first time change is made is useless now and can be deleted. Many checks can be made to verify if the previous exception is detectable, but one example is as follows:
   Check if the previous related exception(s) doesn't have a calendar recurring rule, then it's safe to delete since it is known that it's only for the affected date time.
   Check if the previous related exception(s) have the exact matching calendar recurring rule definition, in that case since the new rule completely overlaps with the previous one(s), they should be safe to delete.
   Check if the new exception, in combination with previous exceptions completely overlaps another previous exception. If this cleaning method is too computationally intensive for each edit, a daemon can be used to clean up the database every once in a while.
When making an edit, it is considered whether if the same result can be accomplished without adding an exception first, so it is not necessary to keep on having to pull down redundant data. An example would be if an additional time slot was added that continues from Monday to Friday, and assigned ticket level “Admission” to it also from Monday to Friday. In this case, if it were preferred to cancel all “Admission” ticket levels from Monday to Friday, instead of creating an exception for it, it may be better to delete the ticket level assignment. That way, it can no longer be needed to pull in data about the ticket-level assignment, and any exception.

### Additional Tables

There are other database tables that help with changes and exceptions, as well as keeping an audit trail of settings and changes that are made by event directors.

There are also tables that get created to hold the associated settings for all the applications like pricing, caps, discounts, etc.

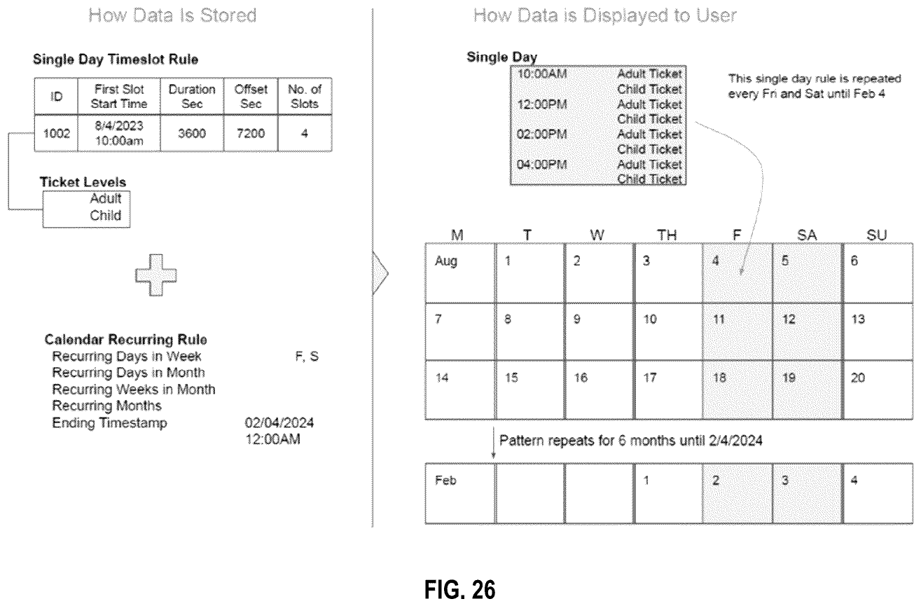

FIG. 26 illustrates the data efficiency of this design and how just one row of data in the Single Day Timeslot Rule and another in the Calendar Recurring Rule can represent 4 available timeslots per day on Friday and Saturday starting August 4th every week for 6 months. That's 216 total timeslots with 2 available ticket levels each timeslot.

### Algorithms and Functions

A set of common algorithms and functions can create an abstraction layer to the data structure and a standard way to interact with the data that can be reused across the applications including, for example, applying time zones and daylight savings time changes, adjusting for leap years and leap seconds, setup of timeslots, rules, exceptions and additional information, retrievals of that information for display purposes in the Event Director Dashboard or in the front end Website and purchase path of ticket buyer, as well as ticket purchases, and reporting of ticket purchases and all financial transactions.

### Event Director Dashboard Applications and User Experience

There are a variety of applications that event directors may need to set up and manage a recurring event.
Features by ticket level, time slot rule, or time slot. Examples of these features are things like pricing, coupons, adding an item from a store like a parking pass, rules for ticket transfer, and caps (the maximum number of tickets for that timeslot or day).
Timeslot rules by group allows a group of timeslots be grouped together with a common set of features like Weekdays having certain hours being one Group and Weekends being another group. Time slot groups provides an easy way for the event director to configure features for all time slots that are a member of a group.
Other features—caps, coupons, store item availability/bundle, season passes, rules for transfer, etc. The database structure allows for additional applications and database tables to be added incrementally, providing a platform for future growth and ability to meet customer needs.
Our design enables not only the efficient management of the features listed in this document, but a framework to easily expand the feature set for time slots and time slot groups. An example of expanded functionality would be being able to Email or Text all ticket holders of a particular timeslot or timeslot group.

### Setting Timeslots and Timeslot Groups

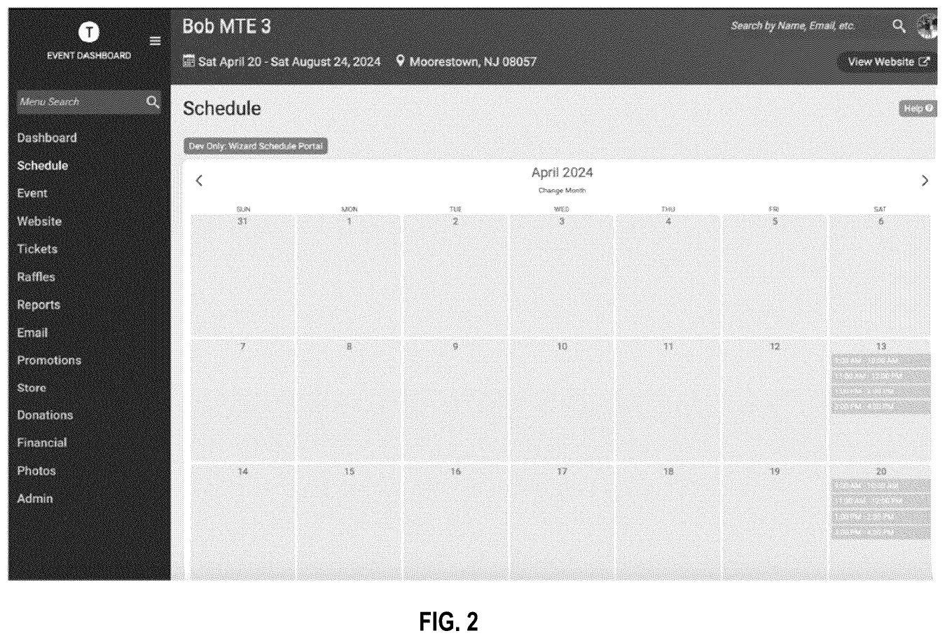

Timeslot Groups are the equivalent to Timeslot Rules. Event Directors can easily add Timeslot Groups with the interface (see FIG. 2). In the Schedule interface the timeslots that have been setup.

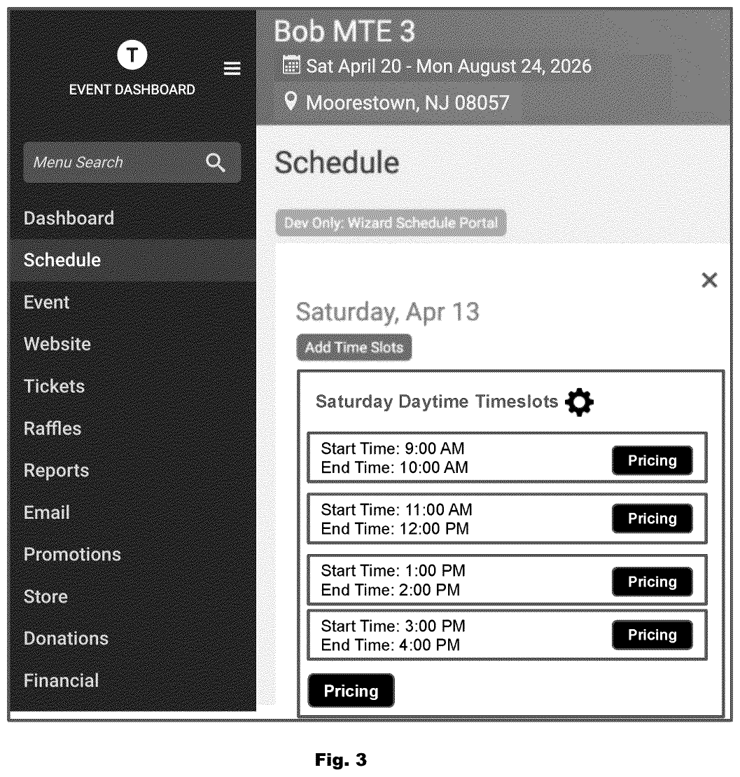

If a day is clicked on, it opens up the Timeslot Groups defined for that day (see FIG. 3). In this example, there is one Timeslot Group called “Saturday Daytime Timeslots”. The gear icon next to the name allows for editing of the Timeslot Group. This functionality will include adding, changing and removing timeslots within a day as well as adding other days to the Timeslot Group.

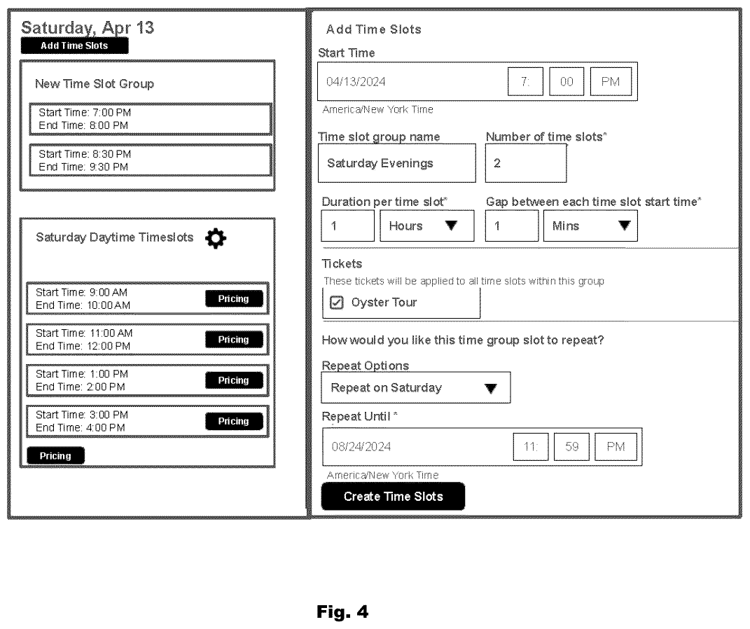

You can also add other Timeslot Groups. The example shown in FIG. 4 adds 2 evening events that are 1 hour in duration with the first event at 7:00 PM and the second event at 8:30 PM every Saturday from Apr. 13, 2024 until Aug. 24, 2024.

The other key item is defining which tickets can be purchased in a timeslot. For example, if there were Child tickets, those might not be available for the evening timeslot group (see FIG. 4).

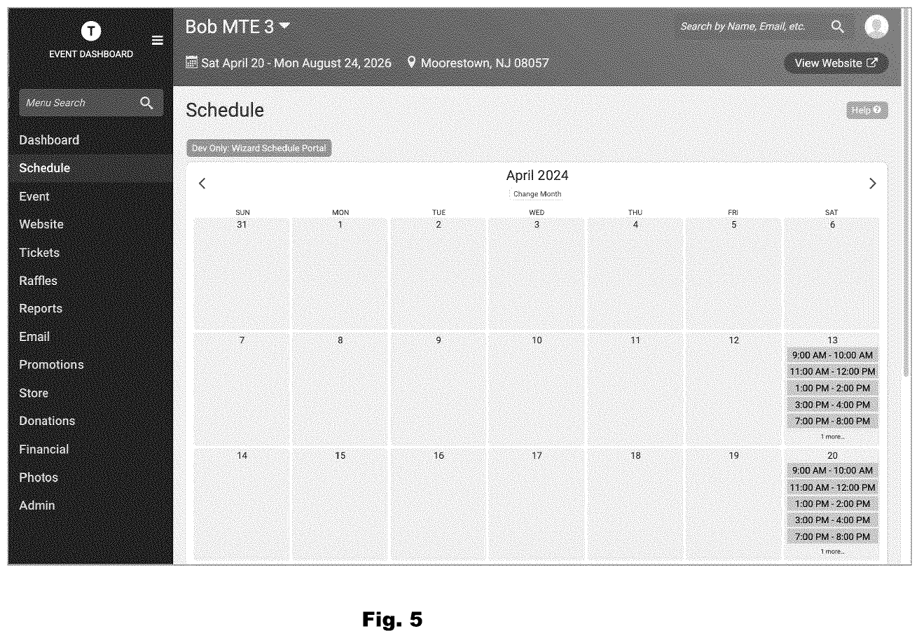

The large Schedule interface is updated, as shown in FIG. 5.

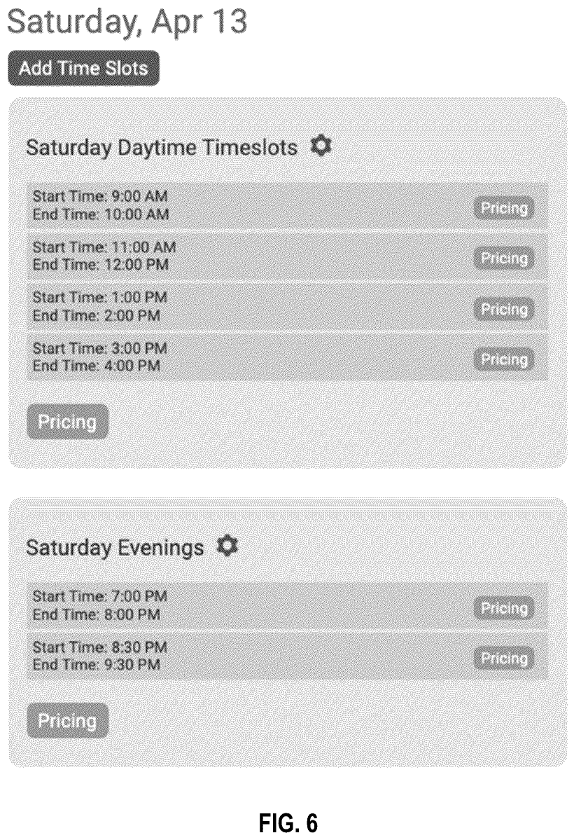

And the day view is updated to show two Timeslot Groups (FIG. 6).

### Pricing

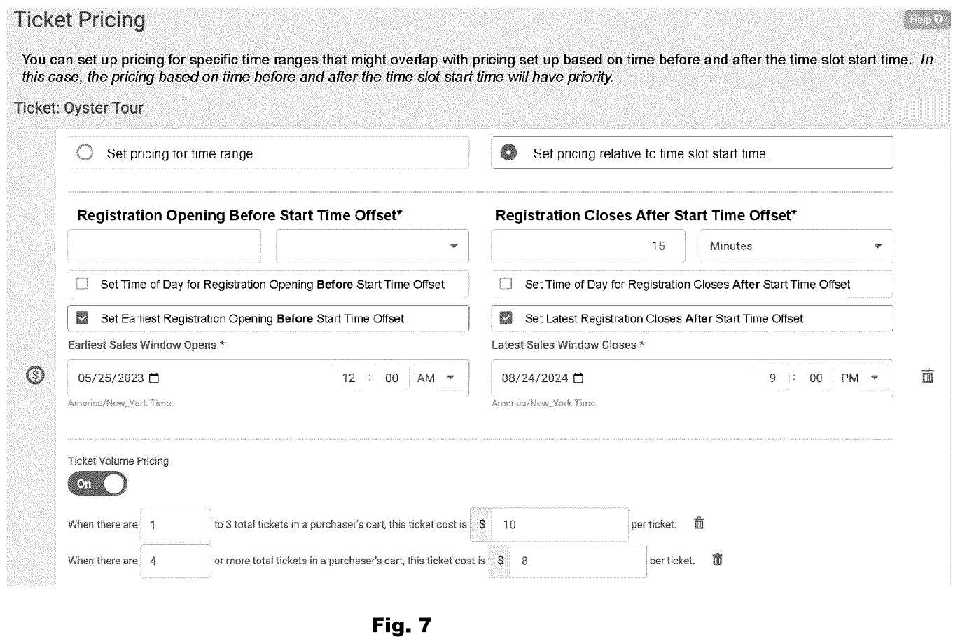

Tickets (called Ticket Levels in the code) can have advanced pricing rules set up on an overall basis in the dashboard. This will set a default pricing for all Timeslot Groups as well as Timeslots (FIG. 7). In some implementations, pricing changes can happen relative to an amount of time before or after an event starts. For instance, prices might rise 7 days before an event happens. The price of tickets can be automatically increased for every timeslot.

In a preferred embodiment the Ticket Purchase Schedule is the first set of parameters to set. Combinations of scheduling can include:
Ticket Sales Start
   For all timeslots on a set date (the example above—which is 05/25/2023)
   Set number of minutes/hours/days before a timeslot begins. This is useful for events that repeat over a long period of time where you do not want to sell tickets more than say 90 days in advance. This can be done on a specific day or specific amount of time before each timeslot. For example, all tickets for April 1 would go on sale on January 1 at midnight. Or on January 1, tickets for the 8:00 AM timeslot would go on sale at 8:00 AM, the 10:00 timeslot would go on sales at 10:00 AM on January 1.
Ticket Sales Close
   Ticket sales for a timeslot can close a set amount of time after or before a start time. In the example above, sales can be set to close 15 minutes after the start time. So tickets would close at 8:15 AM for an 8:00 start time. This can also be a negative number, so tickets could close 1 day before the timeslot.
   Ticket sales can also close on a specific date. This can be useful for events that want to sell all of their tickets say 10 days before the first timeslot starts. For example, a festival might need a specific headcount to know how much food to order.

There can also be multiple purchase periods, which accommodates price increases. For example, prices could be $10 if purchased 90 days before a Timeslot and $15 if between 7-90 days before a Timeslot and $20 if within a week of the Timeslot. This obviously helps events increase more up front cash flow and build a base of ticket buyers who can spread the word about the event.

Volume Pricing is also available in this setup with discounted pricing for buying more tickets. In this example tickets are $10 if 1-3 tickets are purchased, but the price drops to $8 if more than 4 tickets are purchased.

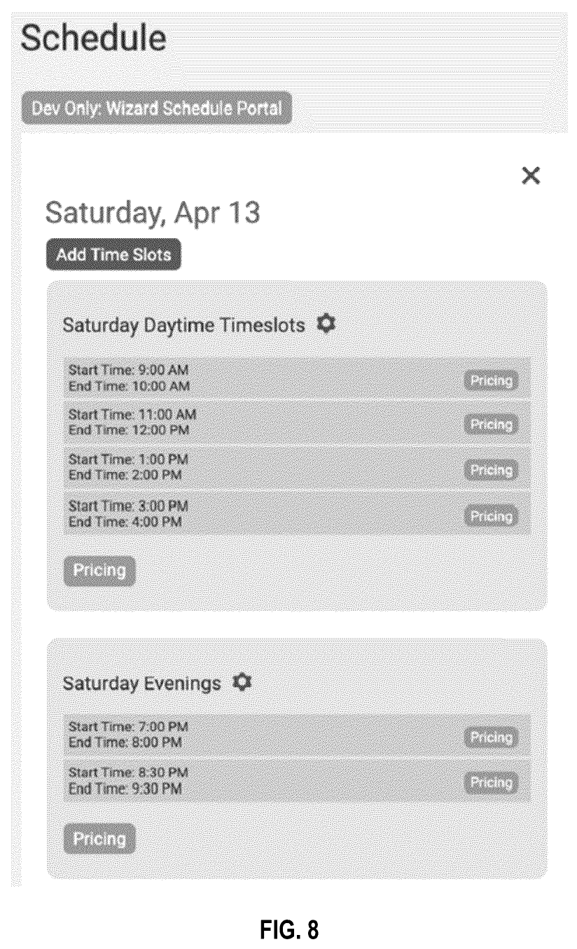

All of three pricing options are available on a per Timeslot Group or individual Timeslot basis from the Schedule page (FIG. 8):

### Additional Settings

The design also accommodates a number of additional settings across Timeslot Groups or individual Timeslots including caps, coupons, store item availability/bundle, season passes, rules for transfer, and others.

### Ticket Buyer User Experience

Our architecture allows for picking the various options in any order:
Date
Timeslot
Ticket Type

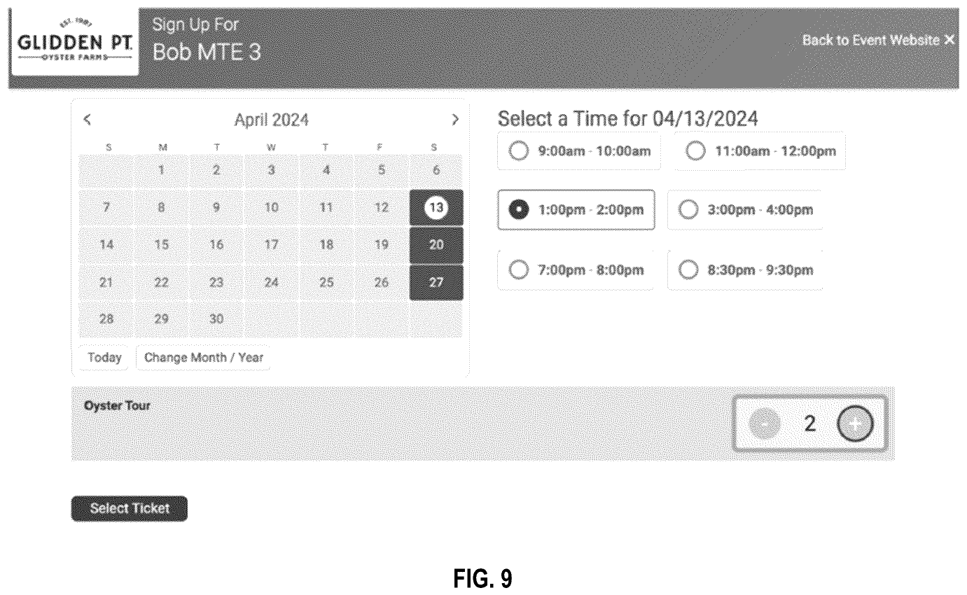

For example, FIG. 9 shows how the user (e.g., buyer) would choose a ticket by selecting Date->Time->Tickets in that order

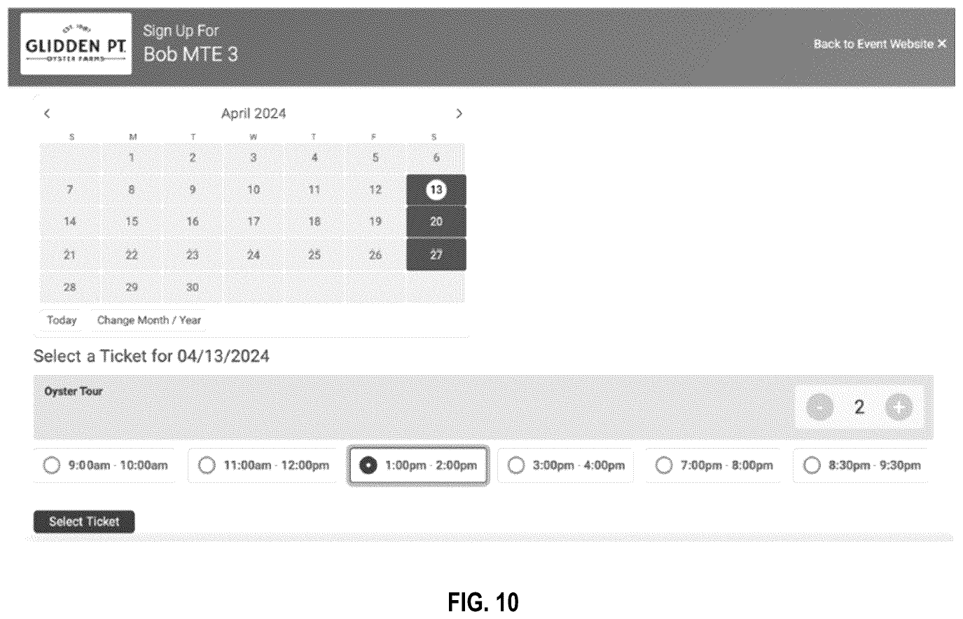

And FIG. 10 shows two different options in the order of Date->Tickets->Time

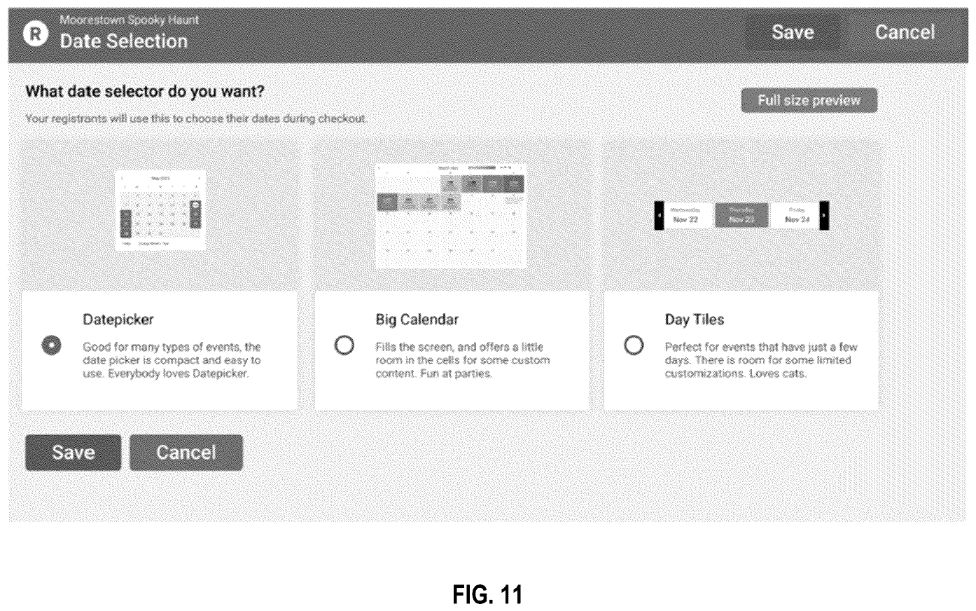

There are a variety of user experience options for event directors to choose from in addition to these. This flexibility improves the user experience based on the number of days, timeslots, and complexity of choices that need to be presented to the purchaser. For example, FIG. 11 shows what some of the date picker options will be.

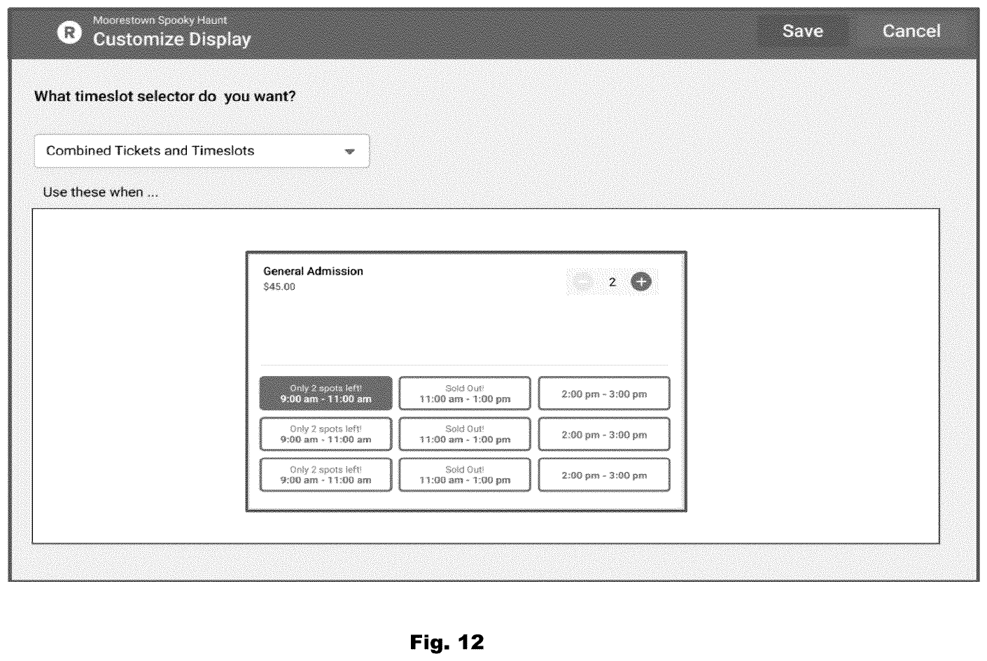

And Timeslots within a date will have more advanced features for displaying data and text and images as shown in FIG. 12. In some implementations, the system can display ticket price and break out associated fees separately based on the location (e.g., state, country, county, city, etc.) the event is located in order to automatically comply with Ticket Pricing Fee Transparency Laws.

Additionally options to group elements together—such as Mornings and Evenings.

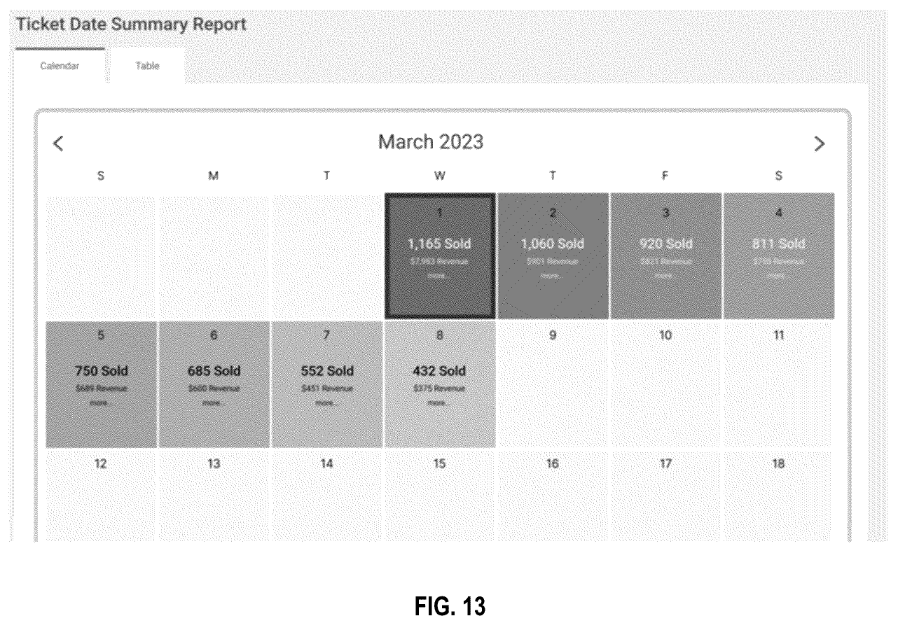

Displays will also be dynamic to show sold out dates, timeslots, prices and tickets remaining as options (FIG. 13).

### Calendar Reports

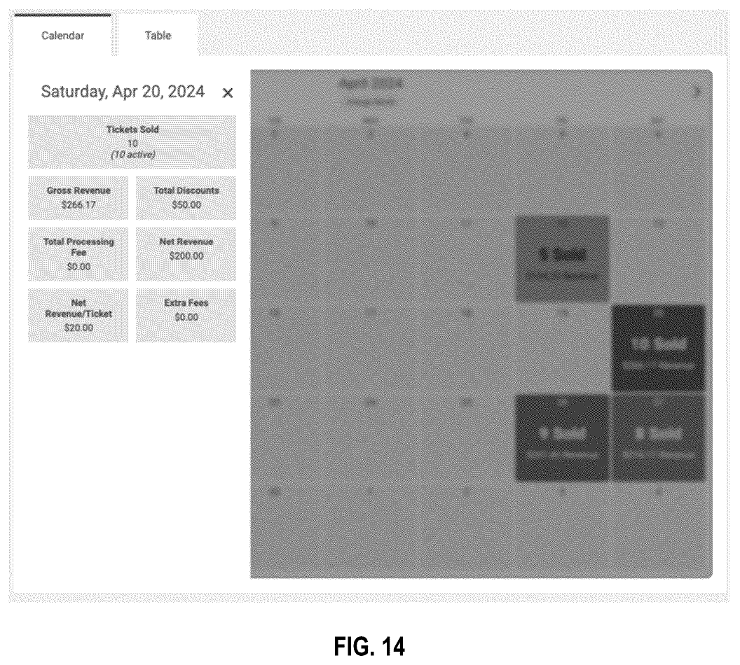

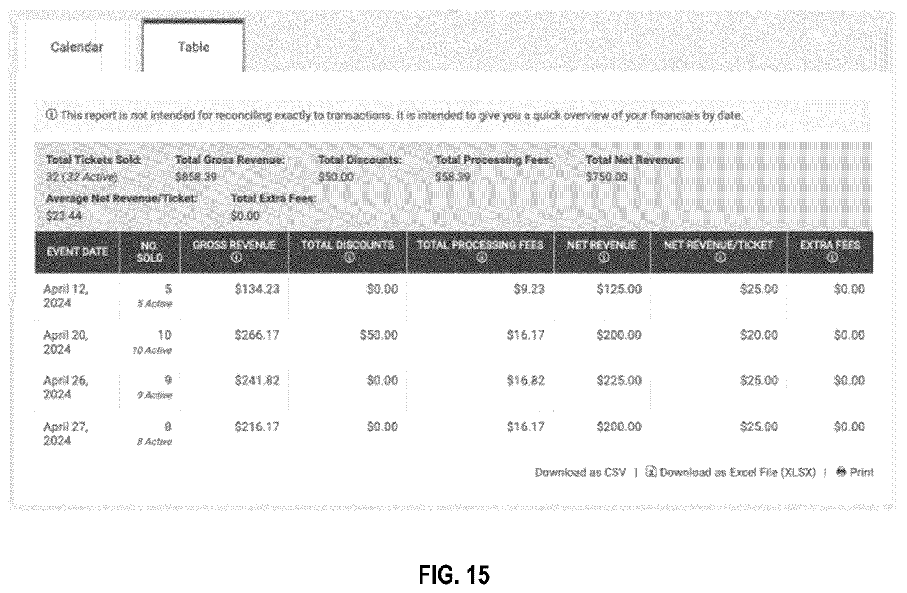

FIG. 13 and FIG. 14 show a calendar based view of reports of tickets sold, which can be color coded by the volume of tickets sold. For example, days on the calendar that sold more tickets are darker while days in which fewer tickets were sold are lighter. This is so, at least in part, such that event planners can have an easier experience to understand nuances of their event and businesses from, helping them to identify opportunities for adjustments in capacity planning and financial optimization with pricing. As shown in FIG. 14, each day on the calendar can be expanded to provide additional information regarding tickets sold for that day. For instance, the information can include total tickets sold (active and/or inactive tickets), gross revenue, total discounts, total processing fees, net revenue, net revenue per ticket, extra fees, and/or the like. In some implementations, the reports can be displayed in a table format as shown in FIG. 15. The table or calendar can be exportable.

### Setup and Edit

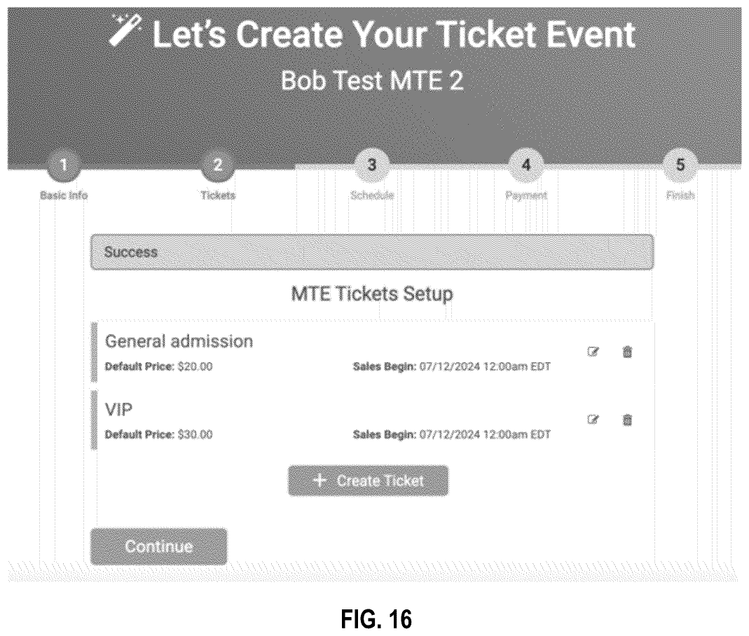

FIGS. 16-23 show example interfaces for setting up and managing ticket events. In some implementations, a timeslot group can be set up for each ticket level and for each day of the week. Ticket level can include, for example, general admission, VIP, and/or the like. As shown in FIG. 16, an event might have two ticket levels, general admission and VIP, in which each have separate rules on timeslots, pricing, and caps. In some cases, the event might also be open only on weekends and/or during holiday seasons. During the initial set up of creating a ticketing event, the system can generate timeslot groups for each ticket level on each day such as, for example, Friday general admission timeslot group, Friday VIP timeslot group, Saturday general admission timeslot group, Saturday VIP timeslot group, and/or the like. In some implementations, the system can automatically assign a color to each ticket level which can be easily identified by users.

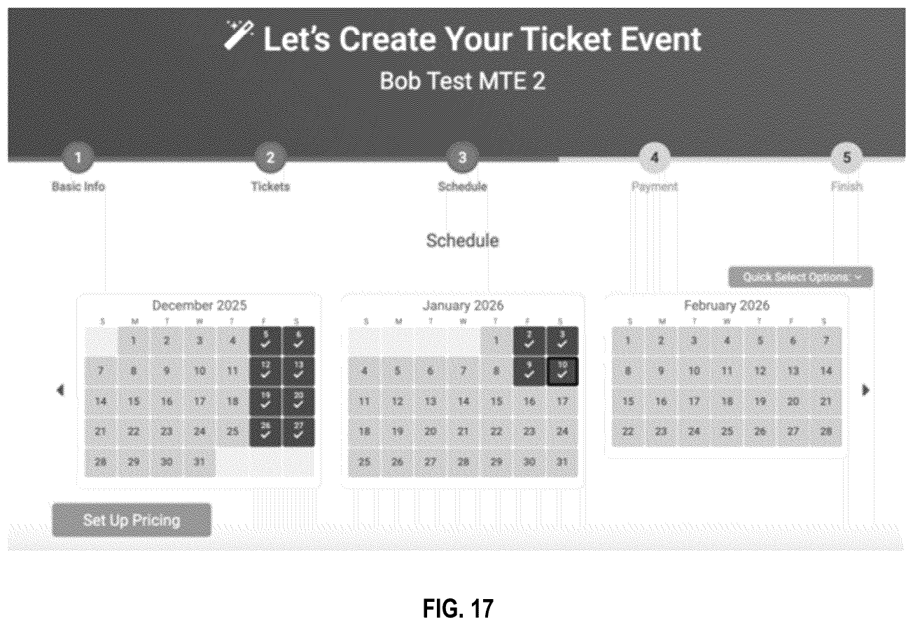

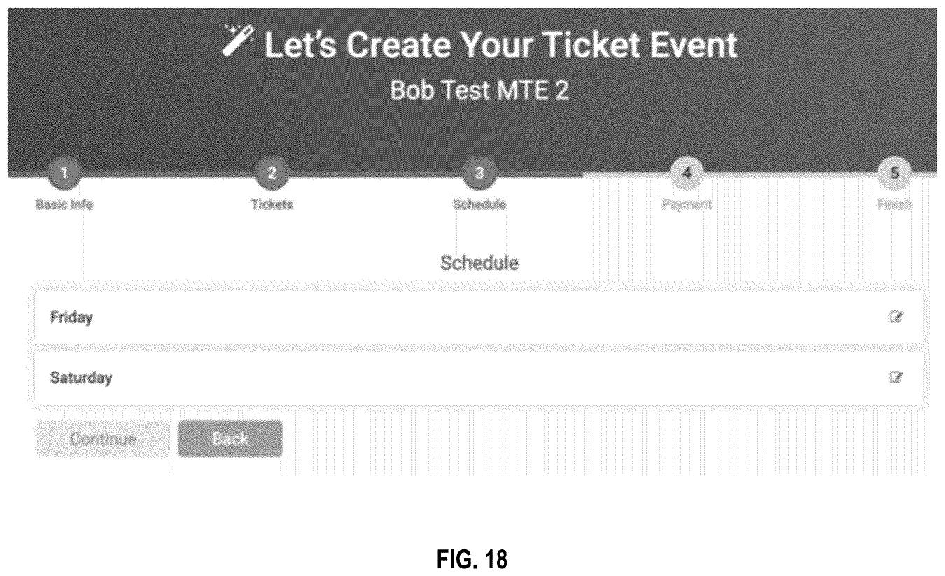

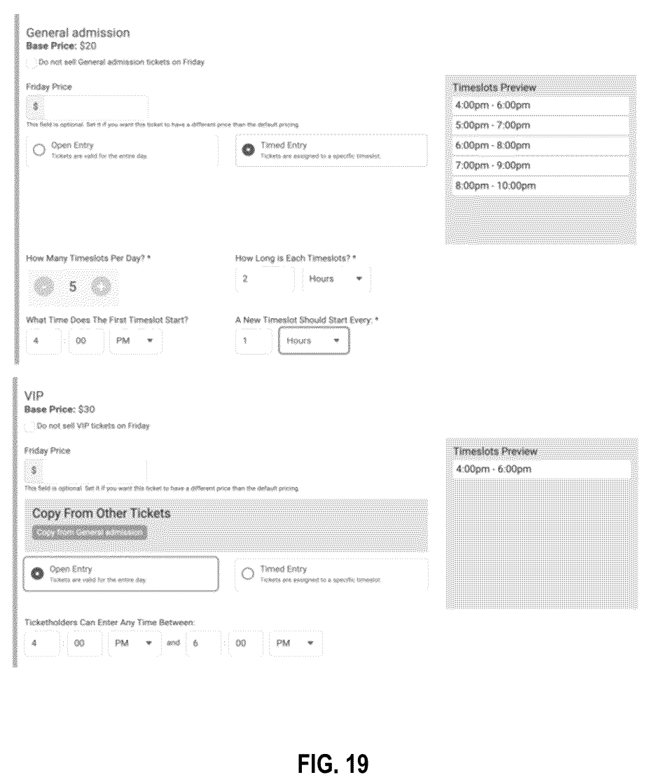

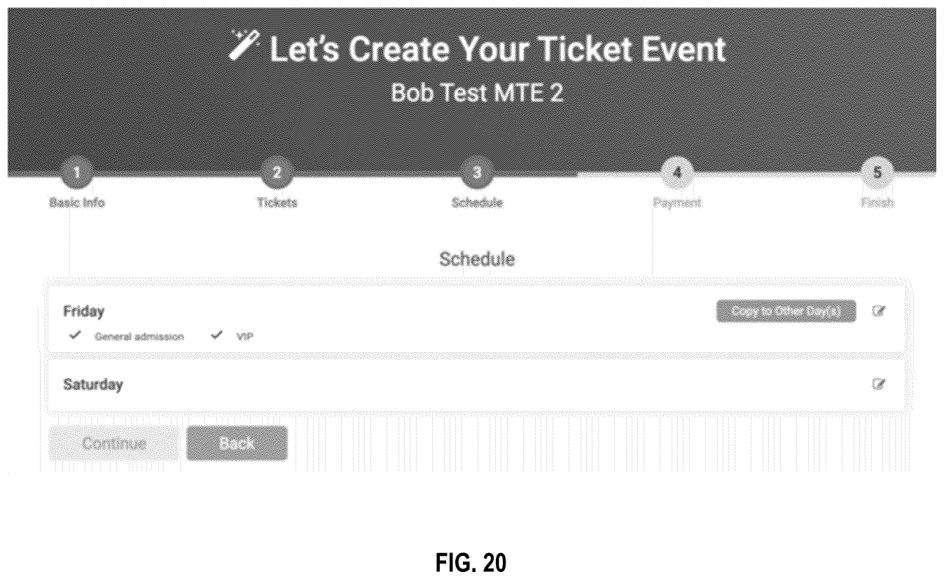

As shown in FIGS. 17-20, an event planner can pick specific days on a calendar image. As shown in FIG. 18, once the days are picked for the event, the days of the week are automatically determined to setup timeslot groups. As shown in FIG. 18, selecting a day will allow the setup of each ticket level and the availability and pricing for that day of the week. For example, the general admission ticket can be for a specific time along with a time limit. The VIP ticket can be for the entire time the event is open. As shown in FIG. 19, the event planner can have the ability to set each timeslot group to either be timed entry (used for General Admission) or open entry (used for VIP). As shown in FIG. 20, the setup for one day can be copied into other days.

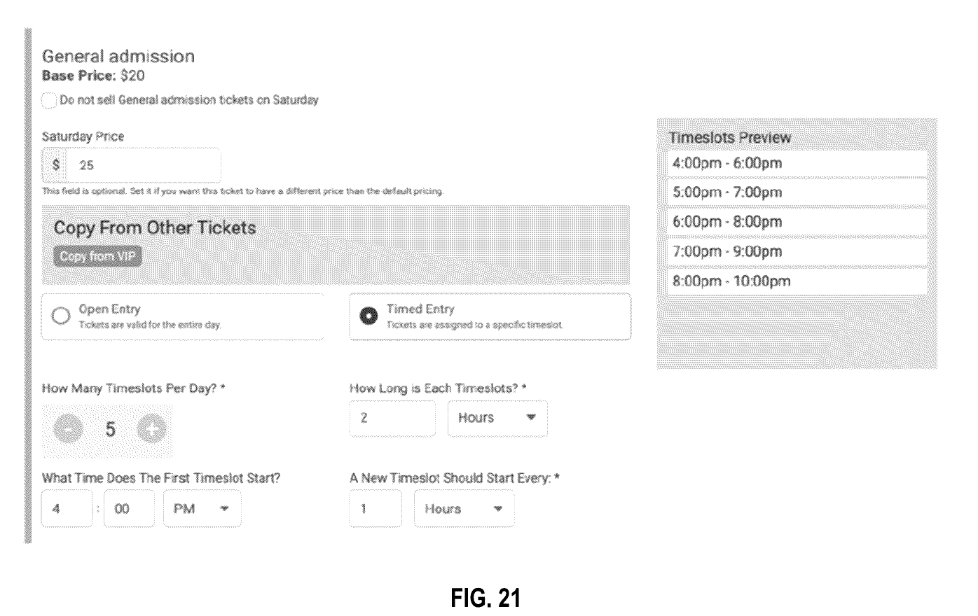

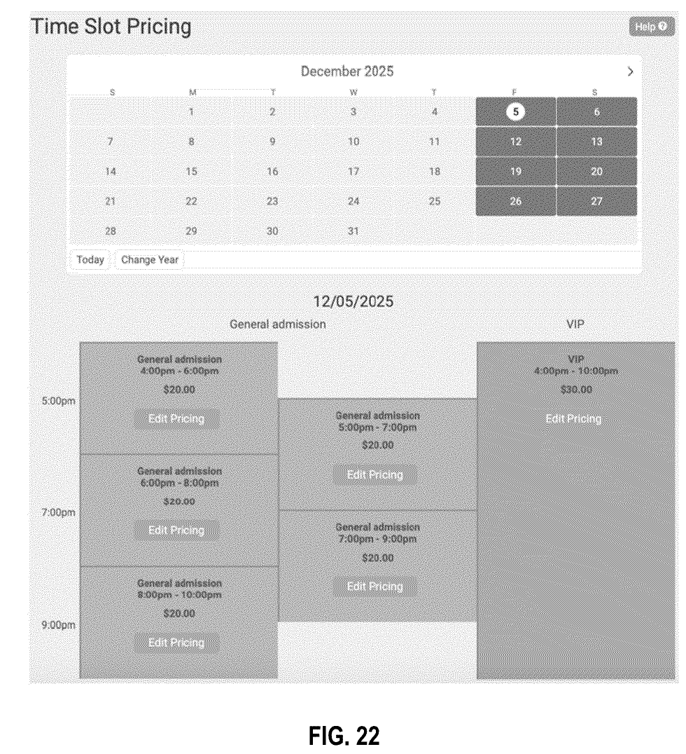

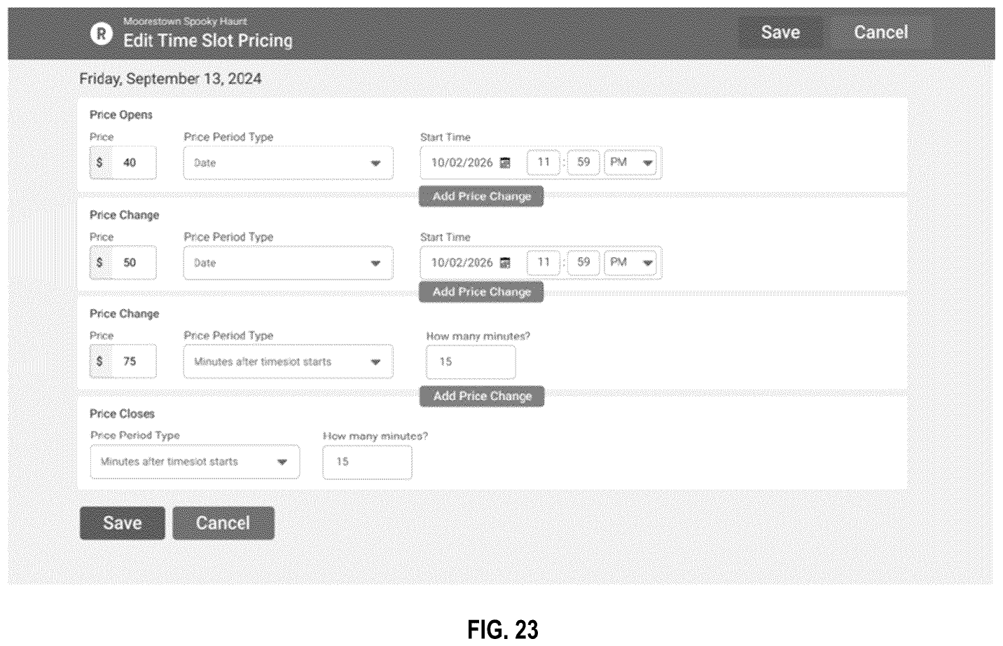

In some cases, each day can be set up with a unique default price for that day and timeslot group. As shown in FIG. 21, the higher price can be set on Saturday after copying everything from Friday. Timeslot groups can be edited following setup. In some implementations, the event planner can add specific and/or unique parameters during edit of setup. For instance, the week before Christmas, prices might change or increase, or caps might be adjusted for Christmas day or specific timeslots. Changes such as, for example, ticket prices, can be made to the timeslot as shown in FIG. 22. For example, a specific day can be picked by the calendar at the top, and can show the available timeslots for each ticket level. As shown in FIG. 23, pricing can be edited for each timeslot.

### SUMMARY

There are three basic processes—one for event directors to setup a recurring event, one for event directors to manage a recurring event, and one for ticket buyers who purchase tickets.

Recurring Event Setup—Event Directors are able to create a recurring event easily via a calendar interface, where they can set up the timing of events, such as how long each event is (a timeslot), how much time there is between events, how many events there are and when they recur—for example on weekdays or only on weekends in October very easily in an intuitive manner. The event setup can also group these events together and apply the specific set of parameters or rules around the event, such as the number of tickets, the price of those tickets, whether there is a cap of the number of tickets as well as if the tickets are transferable and what the price for ticket transfers should be. This setup is unique because of the data storage design in the database which makes it very efficient and scalable. The other unique approach is the calendar user interface which makes it easy to set up recurring events. In addition, this invention allows for exceptions to the rules for recurring events such that individual timeslots or groups of timeslots can have unique rules such as pricing on holidays.

Recurring Event Management—Event Directors are able to easily manage their recurring events with very easy to use calendar based interfaces. The calendar based interfaces allow event directors to report and manage all of the timeslots, groups of timeslots and rules in a visual manner. For example, an event director will be able to see number of tickets sold by timeslot in a calendar interface, and change the rules for pricing, caps, and transfers with a simple point and click interface. This is unique in terms of the calendar interface design, the performance and scalability of the system and the ability to have the mix of recurring rules and exceptions.

Recurring Event Signup—Ticket buyers are presented with calendar based interfaces that allow them to easily see availability and purchase tickets in an intuitive interface. The interface is customized by the event director to provide the best experience for ticket buyers. The uniqueness of the invention is the variety and design of the various interfaces to show ticket availability and the ease of picking the desired timeslot.

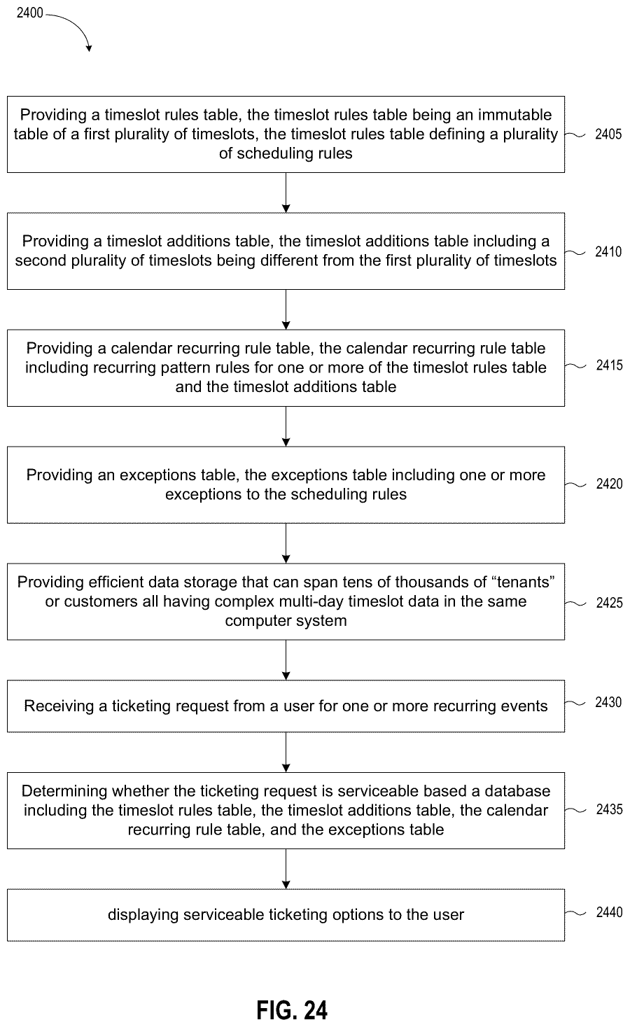

FIG. 24 is an example flow diagram of a method 2400 for event management and participation, according to one or more embodiments. At 2405, the method 2400 includes providing a timeslot rules table, the timeslot rules table being an immutable table of a first plurality of timeslots, the timeslot rules table defining a plurality of scheduling rules.

At 2410, the method 2400 includes providing a timeslot additions table, the timeslot additions table including a second plurality of timeslots being different from the first plurality of timeslots.

At 2415, the method 2400 includes providing a calendar recurring rule table, the calendar recurring rule table including recurring pattern rules for one or more of the timeslot rules table and the timeslot additions table.

At 2420, the method 2400 includes providing an exceptions table, the exceptions table including one or more exceptions to the scheduling rules.

At 2425, the method 2400 includes providing efficient data storage that can span tens of thousands of “tenants” or customers all having complex multi-day timeslot data in the same computer system.

At 2430, the method 2400 includes receiving a ticketing request from a user for one or more recurring events.

At 2435, the method 2400 includes determining whether the ticketing request is serviceable based on a database including the timeslot rules table, the timeslot additions table, the calendar recurring rule table, and the exceptions table.

The method 2400 can be performed by a processor communicatively coupled with memory storing instructions for the processor.

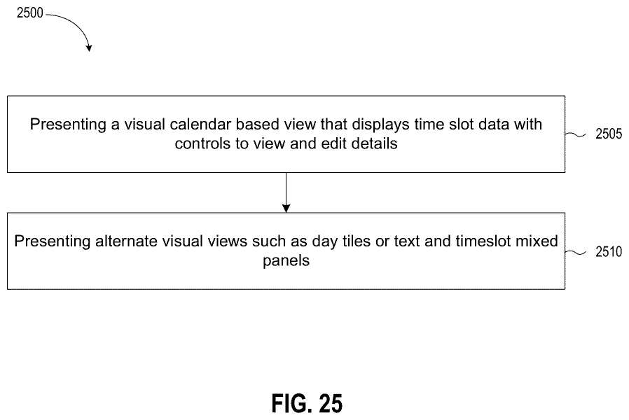

FIG. 25 is an example flow diagram of a method 2500 for presenting complex multi-day recurring timeslot data to event directors in a way that makes it easy to configure events, according to one or more embodiments. At 2405, the method 2500 includes presenting a visual calendar based view that displays time slot data with controls to view and edit details. At 2410, the method 2400 includes presenting alternate visual views such as day tiles or text and timeslot mixed panels. Multiple timeslots can be easily and simply configurable by presenting them as a group and allowing for the configuration of all timeslots in a given group. The method 2500 can be performed by a processor communicatively coupled with memory storing instructions for the processor.

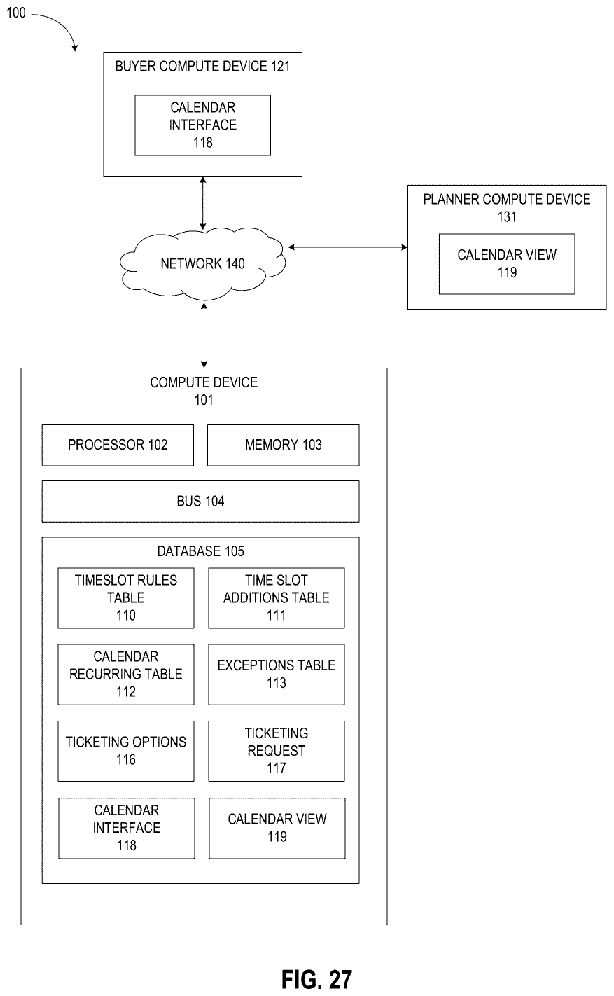

FIG. 27 is a block diagram of a system 100 illustrating multiday timed entry ticket system for recurring events, according to some embodiments. The system 100 can include a compute device 101, a buyer compute device 121, a planner compute device 131, and a network 140 connecting them.

The compute device 101 can be a server or multi-tenant system as described herein. The compute device 101 can include a processor 102 and a memory 103 that communicate with each other, and with other components, via a bus 104. The bus 104 can include any of several types of bus structures including, but not limited to, a memory bus, a memory controller, a peripheral bus, a local bus, and any combinations thereof, using any of a variety of bus architectures. The compute device 101 can be or include, for example, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. The compute device 101 can also include multiple compute devices that can be used to implement a specially configured set of instructions for causing one or more of the compute devices to perform any one or more of the aspects and/or methodologies described herein.

The compute device 101 can include a network interface (not shown in FIG. 27). The network interface can be utilized for connecting the compute device 101 to one or more of a variety of networks (e.g., network 140) and one or more remote devices connected thereto The network 140 can include, for example, private network, a Virtual Private Network (VPN), a Multiprotocol Label Switching (MPLS) circuit, the Internet, an intranet, a local area network (LAN), a wide area network (WAN), a metropolitan area network (MAN), a worldwide interoperability for microwave access network (WiMAX®), an optical fiber (or fiber optic)-based network, a Bluetooth® network, a virtual network, and/or any combination thereof. In some instances, the network can be a wireless network such as, for example, a Wi-Fi or wireless local area network (“WLAN”), a wireless wide area network (“WWAN”), and/or a cellular network. In other instances, the network can be a wired network such as, for example, an Ethernet network, a digital subscription line (“DSL”) network, a broadband network, and/or a fiber-optic network. In some instances, the compute device 101 can use Application Programming Interfaces (APIs) and/or data interchange formats (e.g., Representational State Transfer (REST), JavaScript Object Notation (JSON), Extensible Markup Language (XML), Simple Object Access Protocol (SOAP), and/or Java Message Service (JMS)). The communications sent via the network 140 can be encrypted or unencrypted. In some instances, the network 140 can include multiple networks or subnetworks operatively coupled to one another by, for example, network bridges, routers, switches, gateways and/or the like

The processor 102 can be or include, for example, a hardware based integrated circuit (IC), or any other suitable processing device configured to run and/or execute a set of instructions or code. For example, the processor 102 can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. In some implementations, the processor 102 can be configured to run any of the methods and/or portions of methods discussed herein.

The memory 103 can be or include, for example, a random-access memory (RAM), a memory buffer, a hard drive, a read-only memory (ROM), an erasable programmable read-only memory (EPROM), and/or the like. In some instances, the memory can store, for example, one or more software programs and/or code that can include instructions to cause the processor 102 to perform one or more processes, functions, and/or the like. In some implementations, the memory 103 can include extendable storage units that can be added and used incrementally. In some implementations, the memory 103 can be a portable memory (e.g., a flash drive, a portable hard disk, and/or the like) that can be operatively coupled to the processor 102. In some instances, the memory 103 can be remotely operatively coupled with a compute device (not shown); for example, a remote database device can serve as a memory and be operatively coupled to the compute device. The memory 103 can include various components (e.g., machine-readable media) including, but not limited to, a random-access memory component, a read only component, and any combinations thereof. In one example, a basic input/output system (BIOS), including basic routines that help to transfer information between components within the compute device 101, such as during start-up, can be stored in memory 103. The memory 103 can further include any number of program modules including, for example, an operating system, one or more application programs, other program modules, program data, and any combinations thereof.

The database 105 can store information generated by the processor 102 and/or received at the processor 102. In some implementations, the database 105 can include, for example, hard disk drives (HDDs), solid-state drives (SSDs), USB flash drives, memory cards, optical discs such as CDs and DVDs, and/or the like. In some implementations, the database 105 can include a cloud database, a local database, etc., that can be different from the memory 103. For example, the memory 103 can be volatile, meaning that its contents can be lost when the compute device 101 is turned off. The database 105 can be configured to be persistent, meaning that its contents can be retained even when the compute device 101 is turned off. In some implementations, the database 105 can be configured to organize and manage large amounts of data, whereas the memory 103 can be configured to be used for temporary storage of data and program instructions. In some implementations, the database 105 can be configured to provide efficient and reliable storage and retrieval of data and can include features such as, for example, indexing, querying, and transaction management, while the memory 103 can be configured for rapid access and manipulation of data.

The database 105 can include data a timeslot rules table 110, a timeslot additions table 111, a calendar recurring table 112, an exceptions table 113, ticketing options 116, a ticketing request 117 received from a buyer or user operating the buyer compute device 121, a calendar interface 118, a calendar view 119, and/or the like.

The timeslot rules table 110 can include an immutable table of a first plurality of timeslots, the timeslot rules table defining a plurality of scheduling rules. The timeslot additions table 111 can include second plurality of timeslots being different from the first plurality of timeslots. The calendar recurring table 112 can include recurring pattern rules for one or more of the timeslot rules table and the timeslot additions table. The exceptions table 113 can include one or more exceptions to the scheduling rules.

The ticketing options 116 can include options for purchase of a ticket for an event. Ticketing options 116 can include, for example, specific time slot (e.g., 12 PM, 1 PM, 5 PM, etc.), type of ticket (e.g., general admissions, VIP, etc.), and/or the like. The ticketing request 117 can be a request from the user or buyer to purchase a ticket. The calendar interface 118 can be a user interface and/or visualization that is displayed on the buyer compute device 121 such that the buyer or user can view to consider options for purchase and view additional displayed information in each day that assists with making a purchase decision, be presented with alternate visual views such as day tiles or text and timeslot mixed panels, and/or reduce the number of clicks needed to complete the purchase of one or more tickets out of a plurality of possible ticket options.

The calendar view 119 can be displayed on the planner compute device 131 that displays time slot data with controls to view and edit details and present alternate visual views such as day tiles or text and timeslot mixed panels. Multiple timeslots can be easily and simply configurable by presenting them as a group and allowing for the configuration of all timeslots in a given group.

In some implementations, the memory 103 can store instructions to cause the processor 102 to receive an event request including event data for one or more recurring events from an event planner operating the planner compute device 131. The event data includes parameters for the one or more recurring events, the parameters including an identification number, name, start time, duration, number of recurring events, offsets for the recurring events, and pricing.

The memory 103 can store instructions to further cause the processor 102 to generate, based on the event request, the time slot rules table 110, the timeslot additions table 111, the calendar recurring rule table 112, and the exceptions table 113. In some cases, the processor 102 can be caused to generate additional tables for pricing, capacity for events, and discounts.

The memory 103 can store instructions to further cause the processor 102 to store the timeslot rules table 110, the timeslots additions table 111, the calendar recurring rule table 112, the exceptions table 113, and/or other tables as described herein in the database 105.

The memory 103 can store instructions to further cause the processor 102 to receive the ticketing request 117 from the user or buyer operating the buyer compute device 121 for one or more recurring events associated with the event request made the event planner. The memory 103 can store instructions to further cause the processor to determine whether the ticketing request 117 is serviceable based on the database 105 including the tables.

The memory 103 can store instructions to further cause the processor 102 to generate the calendar view 119 to the planner compute device 119 operated by the planner to enable the planner to modify details of the one or more recurring events. The memory 103 can store instructions to further cause the processor 102 to generate the calendar interface 118 to the buyer compute device 121 operated by the buyer or user to enable the buyer to purchase a ticket for the one or more recurring events.

In some implementations, the database 105 can serve to provide efficient data storage that can span tens of thousands of “tenants” or customers all having complex multi-day timeslot data in the same computer system. The processor 102 can also determine whether the ticketing request 117 is serviceable display serviceable ticketing options to the user or buyer. The processor 102 can also receive a ticketing request confirmation from the user or buyer update the database 105 based on the ticketing request confirmation.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage. In a client/server environment, such software programming code may be stored with storage associated with a server. The software programming code may be embodied on any of a variety of known media for use with a data processing system, such as a diskette, or hard drive, CD-ROM or cloud-based storage. The code may be distributed on such media, or may be distributed to users via SaaS, from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

While there has been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

1. A computer implemented method for event management and participation, comprising:
(a) providing a timeslot rules table, the timeslot rules table being an immutable table of a first plurality of timeslots, the timeslot rules table defining a plurality of scheduling rules;
(b) providing a timeslot additions table, the timeslot additions table including a second plurality of timeslots being different from the first plurality of timeslots;
(c) providing a calendar recurring rule table, the calendar recurring rule table including recurring pattern rules for one or more of the timeslot rules table and the timeslot additions table;
(d) providing an exceptions table, the exceptions table including one or more exceptions to the scheduling rules;
(e) providing efficient data storage that can span tens of thousands of “tenants” or customers all having complex multi-day timeslot data in the same computer system;
(e) receiving a ticketing request from a user for one or more recurring events;
(f) determining whether the ticketing request is serviceable based a database including the timeslot rules table, the timeslot additions table, the calendar recurring rule table, and the exceptions table; and
(g) displaying serviceable ticketing options to the user.

2. The method of claim 1 further comprising:
(h) receiving a ticketing request confirmation from the user; and
(i) updating the database based on the ticketing request confirmation.

3. A computer implemented method for presenting complex multi-day recurring timeslot data to event directors in a way that makes it easy to configure events, comprising:
(a) presenting a visual calendar based view that displays time slot data with controls to view and edit details; and
(b) presenting alternate visual views such as day tiles or text and timeslot mixed panels,
whereby multiple timeslots are easily and simply configurable by presenting them as a group and allowing for the configuration of all timeslots in a given group.

4. An apparatus comprising:
a processor;
a database; and
a memory operatively coupled to the processor, the memory storing instructions to cause the processor to:
receive an event request including event data for one or more recurring events from an event planner operating a compute device;
generate, based on the event request:
a timeslot rules table, the timeslot rules table being an immutable table of a first plurality of timeslots, the timeslot rules table defining a plurality of scheduling rules;
a timeslot additions table, the timeslot additions table including a second plurality of timeslots being different from the first plurality of timeslots;
a calendar recurring rule table, the calendar recurring rule table including recurring pattern rules for one or more of the timeslot rules table and the timeslot additions table; and
an exceptions table, the exceptions table including one or more exceptions to the scheduling rules;
store the timeslot rules table, the timeslots additions table, the calendar recurring rule table, and the exceptions table in the database;
receive a ticketing request from a user operating a compute device for one or more recurring events associated with the event request from the event planner;
determine whether the ticketing request is serviceable based on a database including the timeslot rules table, the timeslot additions table, the calendar recurring rule table, and the exceptions table;
generate a visual calendar based view to the compute device operated by the planner to enable the planner to modify details of the one or more recurring events; and
generate a visual calendar based interface to the compute device operated by user planner to enable the user to purchase a ticket for the one or more recurring events.

5. The apparatus of claim 4, wherein the buyer is further enabled, via the visual calendar based interface, to:
consider options for purchase and view additional displayed information in each day that assists with making a purchase decision;
be presented with alternate visual views such as day tiles or text and timeslot mixed panels; and
reduce the number of clicks needed to complete the purchase of one or more tickets out of a plurality of possible ticket options.

6. The apparatus of claim 4, wherein the memory stores instructions to further cause the processor to:
present a visual calendar based view that displays time slot data with controls to view and edit details; and present
alternate visual views such as day tiles or text and timeslot mixed panels,
whereby multiple timeslots are easily and simply configurable by presenting them as a group and allowing for the configuration of all timeslots in a given group.

7. The apparatus of claim 4, wherein the event data includes parameters for the one or more recurring events, the parameters including an identification number, name, start time, duration, number of recurring events, offsets for the recurring events, and pricing.

8. The apparatus of claim 4, wherein the memory stores instructions that further cause the processor to generate tables for pricing, capacity for events, and discounts.
